(19) United States
(12) Patent Application Publication
(10) Pub. No.: US 2023/0154316 A1
(43) Pub. Date: May 18, 2023

(54) System and Method for Modeling and Simulating a Hyperloop Portal

(71) Applicant: Hyperloop Technologies, Inc., Los Angeles, CA (US)

(72) Inventors: Benjamin Michael Najar-Robles, Torrance, CA (US); Pooya Rahimian, Los Angeles, CA (US); Mohammed Ismaeel Babur, Los Angeles, CA (US)

(73) Assignee: Hyperloop Technologies, Inc., Los Angeles, CA (US)

(21) Appl. No.: 17/964,763

(22) Filed: Oct. 12, 2022

Related U.S. Application Data
(60) Provisional application No. 63/278,493, filed on Nov. 12, 2021.

(51) Int. Cl. G08G 1/01; G06Q 10/06

(52) U.S. Cl. CPC G08G 1/0145; G06Q 10/06315

(57) ABSTRACT

A solution is disclosed for a design system configured to design a transportation network comprising a hyperloop portal. The design system and associated processes are configured to enable a hyperloop designer (or operator) to generate a logical layout of a hyperloop portal. The logical layout may then be used to generate a physical layout that is based on alignment data. The alignment data generally comprises constraints imposed on the hyperloop portal. The solution further optimizes the logical layout, the physical layout, or a combination thereof to generate results for designers to review, simulate, and/or implement in the field. One manner of reviewing the physical layout is to overlay the physical layout on a real-world map.

### CROSS REFERENCE AND PRIORITY TO RELATED APPLICATIONS

This application claims the benefit of priority to: U.S. Provisional No. 63/278,493 entitled “SYSTEM AND METHOD FOR MODELING AND SIMULATING A HYPERLOOP PORTAL,” filed on Nov. 11, 2021.

All the aforementioned applications are hereby incorporated by reference in their entirety.

### BACKGROUND

Hyperloop is a new mode of transportation relying on a hyperloop vehicle traveling through a tube having a near-vacuum environment. The projected velocity of the hyperloop vehicle may exceed 700 mph (1,127 km/h) in commercialized implementations. A hyperloop vehicle may rely on many types of tracks for guidance. However, magnetic levitation (“maglev”) is generally favored over traditional wheeled implementations because maglev provides a substantially frictionless means of guidance, levitation, and propulsion. Having maglev coupled with near-vacuum environments provides for high, sustainable velocities of hyperloop vehicles moving through the tube. Thus, passengers and cargo can be transported with reduced carbon impact.

Many traditional railway stations are outmoded structures that may date back to the mid-19th century. The designs of such railway stations are not optimized for the throughput of trains. For example, many train platforms are terminals where the train stops at the end of a track in order to load and unload cargo (or passengers). Then, the train is reversed to leave the station. Such starting and stopping operations are inefficient. Other sources of inefficiencies plague existing railways stations (e.g., track configurations, bottlenecks, ad hoc maintenance, etc.).

Traditional railway stations are extremely difficult to upgrade. Given the age of such stations, the cities have grown around the stations (e.g., nearby industrial structures). Therefore, the stations as well as surrounding tracks are not cost-effective to upgrade without serious effectns on nearby structures. Even if the tracks could be easily upgraded to support hyperloop, the physical layout (with terminated ends of track) may not even be conducive to hyperloop which often relies on having one-way tracks such that hyperloop vehicles can more quickly traverse a station (or “hyperloop portal”).

Therefore, hyperloop portals may require completely new deployments in the field. However, deployment in dense urban areas may be a challenge for a number of reasons. For example, historical buildings may be protected from destruction, thereby requiring hyperloop portals to be placed around a historical building. In rural settings, hyperloop portals may need to be placed with careful consideration of geographic features (e.g., a steep grade, a lake, etc.).

Existing tools and software are simply not capable of designing and simulating a hyperloop portal when placed in the field. What is needed is a system and method for modeling and simulating a hyperloop portal.

### SUMMARY

A solution is disclosed for designing a transportation network comprising a hyperloop portal. Specifically, the solution comprises a design system, a process, and a computer-readable medium comprising instructions. The solution receives, at a processor, first portal configuration parameters, wherein the first portal configuration parameters are associated with the hyperloop portal. The solution further receives, at the processor, first alignment data, wherein the first alignment data is associated with the hyperloop portal. The solution further generates, at the processor and based on the first portal configuration parameters, a first logical layout, wherein the first logical layout represents the relationships between the first portal configuration parameters. The solution further generates, at the processor and based on the first logical layout and further based on the first alignment data, a first physical layout.

The solution further receives, at the processor, a plurality of design goals, wherein the plurality of design goals is configured to evaluate the first logical layout, the first physical layout, or a combination thereof. The solution further optimizes, at the processor, the first logical layout, the first physical layout, or a combination thereof, wherein the optimizing results in a second plurality of portal configuration parameters. Optimization may be achieved using curvature fitting, geometric alignment, genetic-algorithm alignment, or a combination thereof. The curvature fitting may generate a plurality of curves, wherein the plurality of curves is based on the plurality of design goals and the first alignment data.

The solution further simulates, at the processor, the first physical layout. The solution further evaluates, at the processor, the first physical layout, wherein the evaluating is based on the plurality of design goals and the simulating. The solution further generates, at the processor, a second plurality of portal configuration parameters, wherein the second plurality of portal configuration parameters is based on the evaluating of the second physical layout. The solution further generates, at the processor, a real-world map and generates, at the processor and based on the first physical layout, a second physical layout, wherein the second physical layout is associated with the real-world map.

The first alignment data comprises construction-based constraints, operational-based constraints, geographic-based constraints, legal-based constraints, ingress/egress geometry, ingress/egress grade, horizontal/vertical spacing, geometric entity types, or a combination thereof. The first portal configuration parameters comprise portal ingress parameters, arrival queue parameters, emergency path parameters, branch ingress queue parameters, branch parameters, docking bay parameters, arrival stable parameters, emergency stable parameters, branch stable parameters, stabling egress queue parameters, branch egress queue parameters, portal egress parameters, tube parameters, or a combination thereof.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a block diagram illustrating a transportation network.

FIG. 2 is a block diagram illustrating a design system.

FIG. 3A is a block diagram illustrating a logical layout view represented as portal configuration parameters

FIG. 3B is a block diagram illustrating a logical layout view represented as portal configuration parameters

FIG. 3C is a block diagram illustrating a logical layout view represented as portal configuration parameters

FIG. 4A is a block diagram illustrating a menu.

FIG. 4B is a block diagram illustrating a view.

FIG. 4C is a block diagram illustrating a menu.

FIG. 4D is a block diagram illustrating a view.

FIG. 4E is a block diagram illustrating a plurality of obstacles.

FIG. 4F is a block diagram illustrating a physical layout view.

FIG. 4G is a block diagram illustrating a physical layout view.

FIG. 5A is a flowchart illustrating a process.

FIG. 5B is a flowchart illustrating a process.

FIG. 6 is a block diagram illustrating an example computing device suitable for use with the various aspects described herein.

FIG. 7 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As discussed above, existing railway stations are inadequate for hyperloop deployments. Some railways stations have terminal tracks that require reversing operations to move the train back to the main track. Existing railway stations may also have tunnels, bridges, walkways, etc. that impede the undertaking of upgrading a railway station. In other words, there is a great deal of legacy infrastructure in existing railway terminals—so much so that upgrades are incredibly difficult.

Even if an upgrade to existing railway stations were possible, the need to do so may not make economic or logistical sense. Traditional rail serves a need in society that may not cease even if hyperloop becomes a predominant mode of transportation. For example, heavy loads of cargo may still be carried by traditional rail, especially if the travel times are acceptable as being long in duration. Further, existing railways vehicles (e.g., trains, trolleys, etc.) may have many years of service life remaining; as such, the use of existing railway vehicles may be financially advantageous, at least until the service life has expired. The same may be said of railway-related equipment such as tractors, cranes, loading docks, maintenance bays, etc.

Therefore, hyperloop portals may be, in many situations, built as new structures that are complete with new tracks, stables, walkways, cranes, tractors, emergency paths, etc. However, developers and engineers require tools to design these new portals. A simple sketch on paper will not suffice. Robust and comprehensive tools are needed to design and simulate hyperloop portals. Even if one undertakes the effort to upgrade existing railway stations, the designers of such an upgrade still require tools that address the specifics of hyperloop travel. In other words, existing railway tools may be complementary to the disclosed solution and not to the exclusion of either.

Existing tools used for designing railway stations are wholly inadequate for hyperloop portals. As stated, hyperloop vehicles achieve incredible velocities. Such velocities are achievable by at least two features of hyperloop viz. (1) maglev-based propulsion and (2) near-vacuum operating environments. One of skill in the art will appreciate that maglev often requires different rails than those deployed for traditional rail. As such, maglev rails imply, in most cases, an entirely new deployment of maglev-enabled rails (e.g., laminated steel). Likewise, near-vacuum environments require tube structures and vacuum control equipment. As such, hyperloop operators may need to deploy such tube structures along with any maglev rails. Software tools today simply cannot meet such long-felt needs and use cases.

The disclosed solution provides for software tools that enable designers and engineers to deploy maglev tracks that are surrounded by tube structures having near-vacuum environments. However, the disclosed solution may be used for other track-based modalities of transportation requiring generation of alignments. For example, the disclosed solution may apply to hyperloop implementations that rely on a tube; however, said tube may have a standard air pressure cf. the near-vacuum environments typically used in hyperloop systems. As another example, the disclosed solution may be used for a hyperloop operating without a tube.

Modular construction techniques may be supported by the disclosed solution. In some deployments, the hyperloop tube structures may be prefabricated in sections such that each section is deployed and then connected with other elements in the route. The disclosed solution may consider such modular deployments when configuring a hyperloop portal. Likewise, tracks may be deployed in a modular fashion and be similarly supported by the disclosed solution.

The designing of hyperloop portals is an incredibly difficult undertaking when considering land use. Hundreds if not thousands of constraints must be considered to properly deploy the portal. For instance, the distances between tube structures requires careful calibration to fit within a given footprint of land. In rural areas, the portal constraints may be looser than those in urban areas, where physical constraints introduce complications. However, deployment in urban areas may be economically advantageous because access to passenger and cargo demand is critical to the economic viability of some hyperloop routes. One of skill in the art will appreciate that reducing the footprint decreases costs because the portal simply requires less capital to be spent to acquire land. However, optimizing the land use may require tools and algorithms beyond those in the current state of the art.

Additional constraints may increase challenges when optimizing land use. For passenger transportation via hyperloop, additional structures and systems need to be deployed in the hyperloop portal to support said passengers. For example, the hyperloop portal may require stairs, elevators, baggage claim areas, restrooms, medical services, fire services, police services, access for disabled passengers, restaurants, etc. For cargo transportation via hyperloop, additional structures and systems need to be similarly deployed. For example, the hyperloop portal may need tractors, cranes, conveyor systems, warehouses, loading bays, etc. The placement of the aforementioned examples requires consideration in order to optimize land use.

The disclosed solution may enable designers and engineers to deploy hyperloop portals in a manner that optimizes land use. Such optimization reduces not only costs but time to market. Hyperloop operators must expend large amounts of capital to build out hyperloop infrastructure; the sooner such capital can be returned, the more economically viable the undertaking will be for the operators.

The deployment of hyperloop portals may need to consider existing geographic and manmade constraints. For instance, a hyperloop portal may have an optimal placement in a dense urban area; however, the only remaining parcel may have several historical sites as well as steep hills. A hyperloop portal design, in general, cannot be deployed without consideration of such geographic and/or manmade constraints (e.g., by simply razing entire city blocks of historical buildings). As such, the historical sites and steep hills must be considered when planning the hyperloop portal. One of skill in the art refer to such problems as the “bin packing problem,” where the aim is to maximize the placement of three-dimensional objects to optimize use of space. A similar problem faces hyperloop portal development and deployment—how to account for constraints and optimize accordingly.

The benefits of the disclosed solution are manifold. One advantage is the capability of placing hyperloop portals in locations near passengers and/or cargo that require hyperloop transportation (e.g., portals near dense commercial districts). Another advantage is the capability of designing hyperloop portals within a number of challenging constraints (e.g., placing a hyperloop portal within a mountainous region with protected wildlife). Still another advantage of the disclosed solution is enabling designers to craft hyperloop portals that optimize hyperloop operational efficiency (e.g., by minimizing power-consuming turning operations). Yet another advantage of the disclosed solution is to provide designers with capabilities to reduce the capital expenditure as well as time to market of a new hyperloop portal. Still another advantage of the disclosed solution is optimizing land use.

A key advantage of the disclosed solution is the capability to rapidly visualize and simulate a hyperloop portal. When designers create a hyperloop portal using the disclosed solution, a visualization of the hyperloop portal is available to the designer substantially in real-time. The visualization enables the designer to change the configuration of the hyperloop portal and see the results substantially instantly. Likewise, if the designer is satisfied with the design, a simulation mode is available with which the designer may observe the behavior of a proposed design in operation. For example, the designer may observe hyperloop vehicles traveling through a proposed design—complete with loading and unloading operations. Further, the designer may make revisions and visually see the changes substantially in real-time (e.g., adding additional branches to a portal). One of skill in the art will appreciate that such observations and visualizations may have raw data input and/or output that may be pre-processed or post-processed, thus providing the designer with the capability to share the data with other systems (including existing tools for infrastructure design).

All of the aforementioned advantages, and more, will be apparent to one of skill in the art, as shall be disclosed herein.

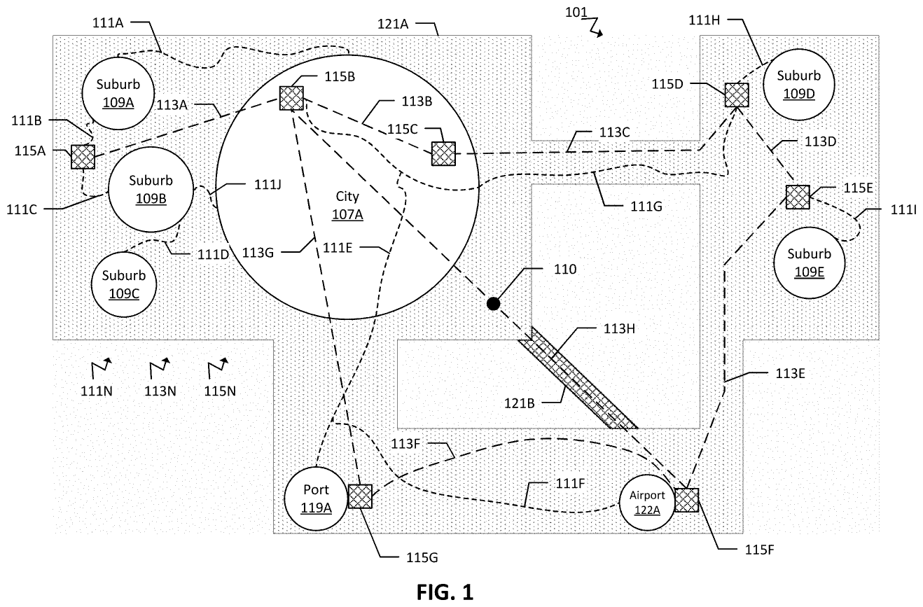

FIG. 1 is a block diagram illustrating a transportation network 101. A hyperloop vehicle 110 is shown in the instant view. The transportation network 101 is deployed within a land area 121A. The land area 121A is defined by a number of parameters. For instance, the land area 121A is defined by land that is owned, purchasable, and/or liquid. In some areas of the world, land is unavailable for use as the land may be designated as a nature preserve, in which case no transportation mode may be deployed therein. In another situation, the land may be unavailable for purchase due to competing economic uses (e.g., an industrial company is using the land for extraction of mineral resources). As such, the land outside the shaded land area 121A may be considered unusable by the transportation network 101.

A city 107A is disposed on the land area 121A. The city 107A is considered a large city (e.g., London, Mumbai, etc.). As such, the city 107A is connected by a myriad of transportation modes including rail, automobile, ship, etc. Many cities are surrounded by smaller municipalities or suburbs. For illustrative purposes, the cities and suburbs referred to herein should generally be considered relative and not exact. For instance, a suburb in China may be considered a large city in Eastern Europe or Australia. One of skill in the art will appreciate that some metropolitan areas are large and some are small.

The land area 121A comprises a first suburb 109A, a second suburb 109B, a third suburb 109C, a fourth suburb 109D, and a fifth suburb 109E. The suburbs 109A, 109B, 109C, 109D, 109E are generally considered metropolitan areas that are smaller in both size and population than a similarly situated city (e.g., the city 107A). In one aspect, the suburbs 109A, 109B, 109C, 109D, 109E may generally be considered single-use areas of land, e.g., a particular suburb may be substantially residential while another suburb may be substantially commercial. On the other hand, the city 107A may be of mixed use where residential, commercial, and industrial use all coexist.

The transportation network 101 comprises a first portal 115A, a second portal 115B, a third portal 115C, a fourth portal 115D, a fifth portal 115E, a sixth portal 115F, and a seventh portal 115G. The portals 115A, 115B, 115C, 115D, 115E, 115F, 115G may form a plurality of portals 115N. The plurality of portals 115N are locations where a hyperloop vehicle may perform a number of actions, including but not limited to: load passengers, unload passengers, load cargo, unload cargo, perform maintenance, remove hyperloop vehicles from service, add hyperloop vehicles to service, change operating personnel, etc. One of skill in the art will appreciate that the plurality of portals 115N may have slightly different functionality but perform many similar functions. For example, a seaport coupled to a portal may have many of the characteristics of a seaport and a train station, plus the unique aspects of hyperloop (e.g., emission-less vehicles, moving platforms, high speeds, etc.).

The transportation network 101 comprises a port 119A. The port 119A may be generally configured to dock ships at berths, in one aspect. For example, cargo is predominately transported by sea via container-based cargo ships. When cargo ships dock, the cargo containers are unloaded onto dry land. Traditionally, a semi-truck arrives with a trailer to receive and deliver cargo containers.

The transportation network comprises an airport 122A. The airport 122A is generally configured to enable air-based modes of transportation (e.g., airplane, helicopter, etc.). In the instant example, the airport 122A serves the city 107A, the port 119A, and the suburbs 109A, 109B, 109C, 109D, 109E.

The portal 115A is connected to the portal 115B via a route 113A. The route 113A is generally configured to provide an operating environment for the hyperloop vehicle. The route 113A, for instance, may be comprised of an elevated series of pylons that support an above-ground tube, i.e., a “hyperstructure.” Within the tube, a near-vacuum pressure environment provides lowered air resistance, thus increasing velocity, energy efficiency, etc. In another aspect, the route 113A may be subterranean and contained within a similar tube as the above-ground example above. While the route 113A, and many other similar illustrations, are denoted with substantially straight lines, one of skill in the art will appreciate that natural curves and turns would be present for a hyperstructure in a commercial deployment.

A route 113B connects the portal 115B to the portal 115C. A route 113C connects the portal 115C to the portal 115D. A route 113D connects the portal 115D to the portal 115E. A route 113E connects the portal 115E to the portal 115F. A route 113F connects the portal 115F to the portal 115G. A route 113G connects the portal 115G to the portal 115B. A route 113H connects the portal 115F, near the airport 122A, to the portal 115B.

The route 113H is disposed along a land area 121B. The land area 121B may be considered a congested area of land that has minimal room for additional hyperloop tracks disposed along the route 113H. On the one hand, the route 113H provides substantially direct access between the airport 122A and the city 107A. On the other hand, the route 113H may become quickly overwhelmed by traffic demand, due in part to the narrowness of the land area 121B.

The routes 113A, 113B, 113C, 113D, 113E, 113F, 113G forma plurality of routes 113N having substantially similar characteristics. One of skill in the art will appreciate that the plurality of portals 115N and the plurality of routes 113N are used for illustrative purposes and may have multiple instances within a particular location. For instance, the portal 115A may be comprised of three smaller portals (not shown) that form a discrete transportation network. The plurality of routes 113N may be comprised of hyperstructure that may be subterranean, underwater, on-ground, above-ground, or a combination thereof.

A plurality of roads 111N is comprised of a first road 111A, a second road 111B, a third road 111C, a fourth road 111D, a fifth road 111E, a sixth road 111F, a seventh road 111G, an eighth road 111H, a ninth road 111I, and a tenth road 111J. The plurality of roads 111N support any existing mode of ground transportation, including, but not limited to, automobile, rail, trolley, subway, bus, or a combination thereof. In modernized cities, high-speed rail may be considered a right-of-way user of the plurality of roads 111N. One of skill in the art will appreciate the plurality of roads 111N is utilized for illustrative purposes and may, in one aspect, simply be the means by which an existing, non-hyperloop vehicle travels.

The road 111A connects the suburb 109A to the city 107A. The road 111B connects the portal 115A to the suburb 109A. The road 111C connects the portal 115A to the suburb 109B. The road 111D connects the suburb 109B to the suburb 109C. The road 111E connects the port 119A to the city 107A. The road 111F connects the airport 122A to the road 111E. The road 111G connects the city 107A to the portal 115D. The road 111H connects the portal 115D to the suburb 109D. The road 111I connects the portal 115E to the suburb 109E. The road 111J connects the city 107A to the suburb 109B.

In one aspect, the suburbs 109A, 109B, 109C, 109D, 109E are connected to the city 107A. In many metropolitan areas, people reside in suburbs and commute to larger city centers. The cities generally have more commercial and industrial opportunities for workers. Stated differently, the land use in the suburbs 109A, 109B, 109C, 109D, 109E may be quite different than that of the city 107A because the suburbs 109A, 109B, 109C, 109D, 109E are primarily residential, and the city 107A is mixed-use. One reason for the difference is simply the land use density viz. city use is denser than suburban use.

In one aspect, the hyperloop portal 115A is an example of how the suburbs 109A, 109B may utilize hyperloop. For instance, a worker living in the suburb 109A may take the road 111B to the portal 115A where the worker may park the car in a garage. Then, the worker may use the hyperloop route 113A to arrive at the portal 115B within the city 107A. The worker could then walk to a nearby place of work (e.g., an office complex).

In another example, the hyperloop portal 115E is positioned at the right side of the land area 121A. One of skill in the art will appreciate that most of the suburbs 109A, 109B, 109C, 109D, 109E are connected by the plurality of roads 111N. However, the introduction of the hyperloop portal 115E in the righthand area of the land area 121A provides an opportunity for land use at and around the hyperloop portal 115E.

The plurality of roads 111N and the plurality of routes 113N form a mesh by redundantly connecting many points within the transportation network 101 (e.g., the suburb 109B has several entries and exits). In contrast, the portal 115E is only connected by the hyperloop route 113D. Such a deployment is an example of how a hyperloop portal may encourage growth in an underutilized area of land. A new, efficient mode of transportation like hyperloop may encourage people in the city 107A to purchase land in the vicinity of the portal 115E in order to avoid congestion, noise, pollution, inadequate schools, crime, etc. However, such increase in population density may correspondingly increase traffic demand which influences the configuration of portals.

The topology of the transportation network 101 is influenced by a number of factors. For example, the suburb 109E is connected to the road 111I that leads to the portal 115E. One of skill in the art will appreciate how the use of roads to and from the suburb 109E is minimal due to (1) the proximity of the portal 115E and (2) the suburb 109E being built with the portal 115E as a primary mode of transportation for the area. Therefore, the inhabitants of the suburb 109E largely rely on hyperloop for transportation needs when traveling beyond the nearby area of the suburb 109E. As such, the inhabitants of the suburb 109E may rely on fewer transportation modes. In contrast, the inhabitants of city 107A have multiple points of access to roads and hyperloop routes. Such considerations may affect traffic demand viz. inhabitants in the suburb 109E may place more demand on the hyperloop routes in the vicinity of the suburb 109E compared to roads in the same area. In short, hyperloop portals need to consider the demographics of the areas serviced in order to configure a hyperloop portal for the deployment environment.

A hyperloop portal 115F is positioned substantially near the airport 122A to illustrate that in some implementations, a portal may be tightly coupled to a nearby location. In the instant example, the airport 122A may unload passengers, near the portal 115F, directly into hyperloop vehicles traveling toward the city 107A. A portal 115G is shown as being tightly coupled to the port 119A. In one aspect, cargo ships docking at the port 119A may unload cargo containers bound for the city 107A. Prior to the introduction of the portal 115G, cargo had to be carried via the road 111E using traditional semi-trucks.

The route 113G connects the portal 115G to the portal 115B. The route 113G may be specially configured to carry cargo-laden hyperloop vehicles, that are destined for the city 107A, in one aspect. In another aspect, the hyperloop vehicles traveling along the route 113G may be a mix of passenger-configured and cargo-configured hyperloop vehicles. The route 113F connects the portal 115G to the portal 115F and may be utilized for a combination of passenger and cargo traffic. For instance, passengers may arrive at the airport 122A, enter the portal 115F, travel via the route 113F to the portal 115G, and finally travel along the route 113G to arrive at the portal 115B. In another example, cargo may be offloaded from airplane at the airport 122A and then be transported to the port 119A via the route 113F. Likewise, the cargo may be transported between the port 119A and the city 107A (or to any other destination).

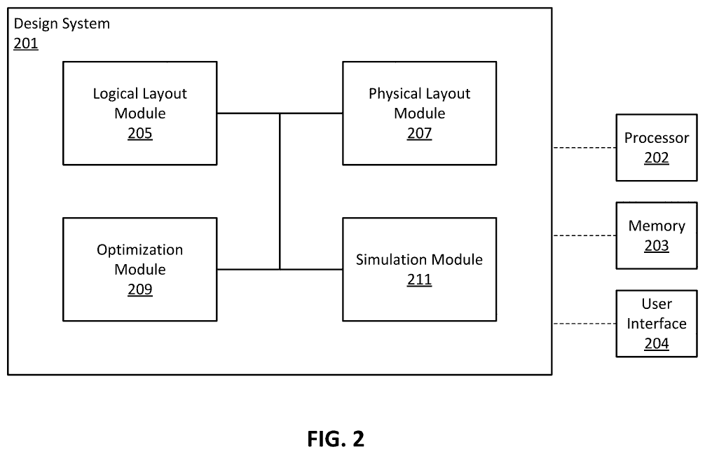

FIG. 2 is a block diagram illustrating a design system 201. The design system 201 comprises a logical layout module 205, a physical layout module 207, an optimization module 209, a simulation module 211, a processor 202, a memory 203, and a user interface 204.

The logical layout module 205 is generally configured to generate logical layouts of the transportation network 101. A hyperloop portal, like anything, is comprised of component parts. For example, a portal may have a branch, a docking bay, a stable, an emergency path, etc. The logical layout module 205 enables designers to develop logical relationships between the components of a hyperloop portal in order to generate a logical layout, which is configured to relate the various components of portal configuration parameters. For example, the logical layout module 205 provides, at the user interface 204, a graphical interface such that a user can associate two component parts such as an arrival queue and a docking bay.

The physical layout module 207 is generally configured to generate physical layouts of the transportation network 101. The design system 201 enables, via the logical layout module 205, a designer to create the logical relationships between the components of a portal (e.g., the portal 115A). However, a logical layout is not capable of being implemented by civil engineering because the physical aspects as alignment data (e.g., track deployed on terrain) have not been processed by the design system 201. Therefore, the physical layout module 207 is configured to generate a physical layout based on the logical layout generated at the logical layout module 205.

The optimization module 209 is generally configured to optimize a logical layout, a physical layout, or a combination thereof. In general, the design system 201 is configured to enable a human user (e.g., a designer) to create a component of the transportation network 101, for instance the portal 115C. The designer will generate a design in the logical layout module 205 via the user interface 204. Once that logical layout has been created, the optimization module 209 is configured to perform optimizations on the logical layout. Once the logical layout optimization has completed, the optimization module 209 may then optimize the physical layout.

Optimization may be based on various goals set by designers, operators, engineers, etc. For example, an optimization to a logical layout may be to generate a number of queues that meet the typical rush-hour traffic demand. Such an optimization is one that is suited to be optimized at the logical layout level first because the selection of the queues would need the business case before being implemented at a physical level. However, a physical layout optimization may relate to reducing the amount of underground track because the soil is difficult to bore.

Typical optimizations for a logical layout include: reducing routes, reducing loading bays, reducing track switching, increasing redundancy, increasing safety, etc. Physical layout optimizations include: bin packing, reducing grade changes, minimizing capital costs, avoiding physical obstructions, utilizing rights-of-way, etc.

The simulation module 211 is generally configured to perform a simulation of the designed transportation system 201 and/or the other components thereof (e.g., the hyperloop portal 115D). The logical layout module 205 is configured to generate a logical layout. However, the logical layout may need to be simulated for validation. For instance, a portal may have a minimum per-hour throughput of hyperloop vehicles, even in the best of situations. Therefore, the simulation module 211 may provide simulation data relating to expected real-world operation of the designed system. For instance, the simulation module 211 may generate a simulation that indicates that the number of portals causes the schedules to be missed since each portal imposes a minimum delay on each hyperloop vehicle.

Simulations may also relate to the physical operation of the physical layout. For example, a physical layout may be optimized (via the optimization module 209) in order to reach a goal, such as minimizing infrastructure costs. To validate and test the optimized result, the simulation enables designers to visually interact with a transportation network configuration. Interaction by the human designers is enabled via the user interface 204. For instance, the user interface 204 may be a virtual reality interface configured to interact with the physical layout.

The processor 202 may be a shared processor which is utilized by other systems, modules, etc. within the disclosed solution. For example, the processor 202 may be configured as a general-purpose processor (e.g., x86, ARM, etc.) that is configured to manage operations from many disparate systems, including the design system 201. In another aspect, the processor 202 may be an abstraction because any of the modules, systems, or components disclosed herein may have a local processor (or controller) that handles aspects of the design system 201 (e.g., ASICs, FPGAs, etc.).

The memory 203 is generally operable to store and retrieve information. The memory 203 may be comprised of volatile memory, non-volatile memory, or a combination thereof. The memory 203 may be closely coupled to the processor 202, in one aspect. For example, the memory 203 may be a cache that is co-located with the processor 202. As with the processor 202, the memory 203 may, in one aspect, be an abstraction wherein the modules, systems, and components each have a memory that acts in concert across the design system 201.

The user interface 204 is generally configured to enable a user to view, manipulate, store, print, transfer, and/or receive data and information related to inputs and outputs of the design system 201. For example, the user interface 204 may be a desktop computer configured to use software embodying the design system 201. One of skill in the art will appreciate that the user interface 204 may be a laptop, a desktop, a tablet, a smartphone, a web-based application, a desktop application, a mobile application, or a combination thereof. In one aspect, the user interface 204 may be virtual-reality-based.

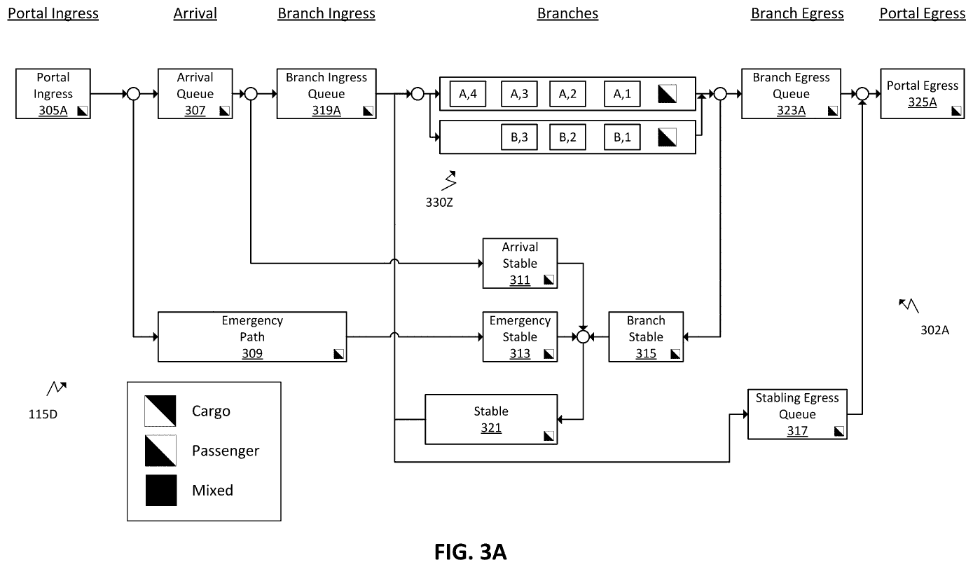

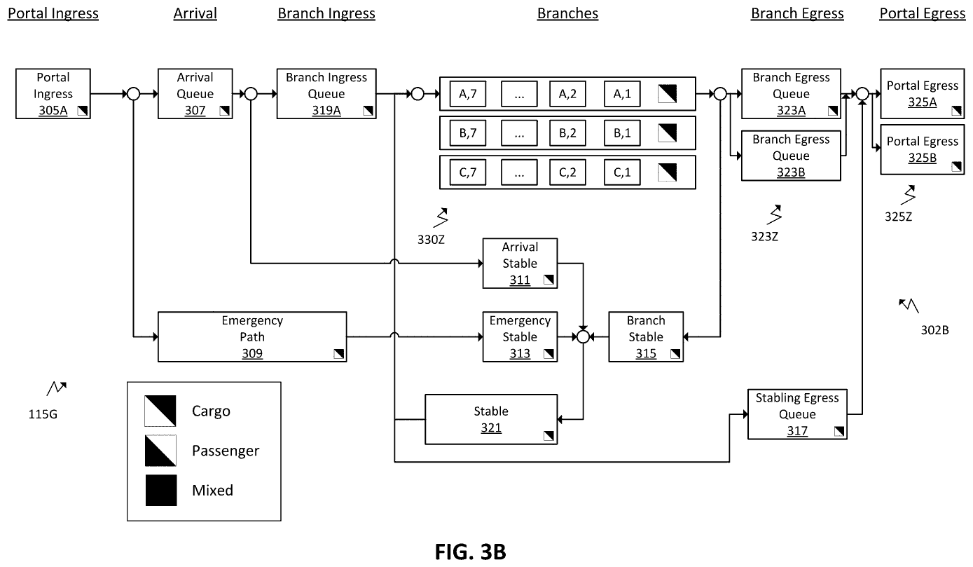

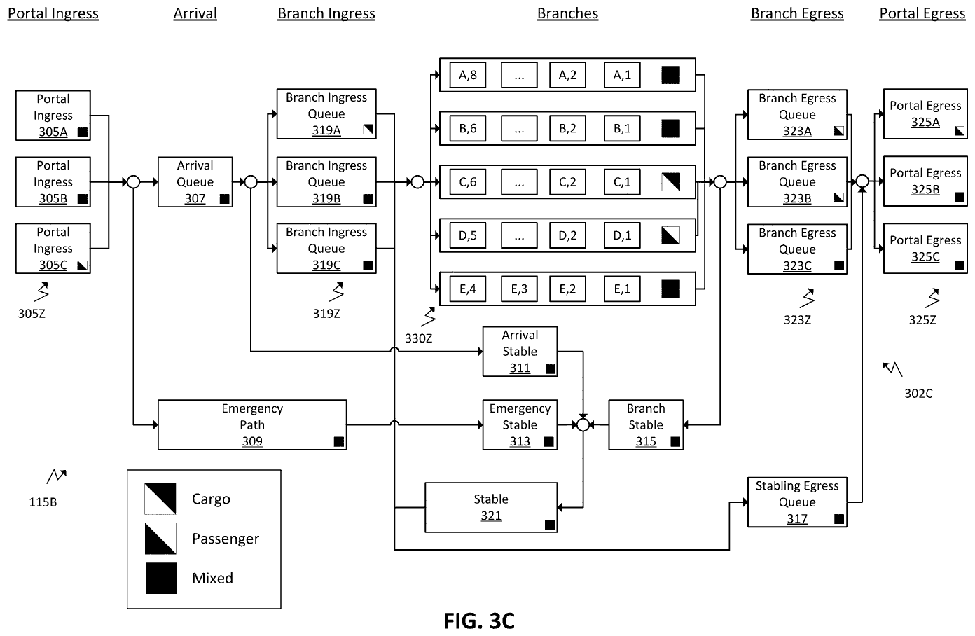

FIG. 3A is a block diagram illustrating a logical layout view represented as portal configuration parameters 302A. FIG. 3A, FIG. 3B, and FIG. 3C each show examples of how various hyperloop portals may be configured using the design system 201. FIG. 3A generally relates to cargo transportation. FIG. 3B generally relates to passenger transportation. Lastly, FIG. 3C generally relates to mixed use by both passenger and cargo.

The portal configuration parameters 302A represent the hyperloop portal 115G in a logical layout that is storable and executable by a computer, computing device, server, etc. The portal configuration parameters 302A comprise a number of configurable elements such that designers may adjust the hyperloop portal configuration substantially in real-time. Examples of such configurable elements may relate to one or more portal configuration parameters 302A. For example, the cost of infrastructure may apply to both arrival stables as well as loading docks. Configurable elements of the portal configuration parameters 302A include: queue size, queue length, queue layout, branch type, queue shape, direction, transponder information/location, elevation, or a combination thereof.

However, alignment data may not be as configurable—rather, the alignment data is generated based on a physical layout (and optimizations relating thereto). Alignment data is generally based on the physical constraints (e.g., parcel dimensions and/or shape) of the portal design as represented logically by the portal configuration parameters 302A. For example, the alignment data may comprise construction-based constraints, operational-based constraints, geographic-based constraints, legal-based constraints, ingress/egress geometry, ingress/egress grade, horizontal/vertical spacing, geometric entity types, or a combination thereof.

Geospatial data is generally data and/or constraints that affects the configuration of alignment data. Example of geospatial data include: grade, terrain, locations of natural features, elevation, soil composition, real estate value, government-controlled locations, rights-of-way locations, water levels, historic wind speeds, historic temperatures, historic humidity, or a combination thereof. On the other hand, the travel time of the hyperloop vehicle 110 may not be as configurable—rather the physical representation of the portal configuration parameters 302A may determine and measure the travel time during simulation.

Stated differently, the portal configuration parameters 302A may be a logical representation (i.e., logical layout) of a hyperloop portal where varied instances of alignment data satisfy the configuration of the portal configuration parameters 302A. For instance, the portal configuration parameters 302A may require three loading bays, but the alignment of three loading bays may be represented by many instances of alignment data, all of which have the same logical representation of a hyperloop portal (as stored in the portal configuration parameters 302A) but different physical configurations (as influenced by alignment data). Further, geospatial data may affect the logical layout and/or the physical layout depending on the context.

The portal configuration parameters 302A may be stored in a number of formats. For example, the portal configuration parameters 302A may be stored in JSON, KML, XML, HTML, SQL, comma-separated format, or a combination thereof.

As stated, the portal configuration parameters 302A generally relate to cargo transportation. The hyperloop portal 115D is shown as a logical layout embodied by portal configuration parameters 302A. As noted by the symbol on each component, the entirety of the hyperloop portal 115D is dedicated to cargo.

The portal configuration parameters 302A comprise a portal ingress 305A. The portal ingress 305A comprises a position in the hyperloop portal 115D where the hyperloop vehicle 110 arrives at the hyperloop portal 115D.

The portal configuration parameters 302A further comprise an arrival queue 307. The arrival queue 307 comprises a position in the hyperloop portal 115D where the hyperloop vehicle 110 may wait for a branch ingress queue position or an arrival stabling position.

The portal configuration parameters 302A further comprise a branch ingress queue 319A. The branch ingress queue 319A comprises a position in the hyperloop portal 115D where the hyperloop vehicle 110 waits for a docking bay within a plurality of branches 330Z.

The portal configuration parameters 302A further comprise the plurality of branches 330Z. The plurality of branches 330Z comprises a plurality of hyperloop vehicle docking bays. For instance, the reference [A, n] represents the nth docking bay in the plurality of branches 330Z in the A array. One of skill in the art will appreciate how the array of docking bays is represented as a logical array in the instant figure. A docking bay is generally configured to receive the hyperloop vehicle 110 at a platform in order to perform loading operations, unloading operations, servicing operations, or a combination thereof.

The portal configuration parameters 302A further comprise an arrival stable 311. The arrival stable 311 provides stabling for the hyperloop vehicle 110 if the hyperloop vehicle 110 needs to be stabled prior to entering the plurality of branches 330Z.

The portal configuration parameters 302A further comprise an emergency path 309. The emergency path 309 is generally configured to divert a distressed hyperloop vehicle to an emergency stable 313.

The portal configuration parameters 302A further comprise the emergency stable 313. The emergency stable 313 provides stabling for a distressed hyperloop vehicle such that engineers may service the hyperloop vehicle 110 (and potentially conduct rescue operations).

The portal configuration parameters 302A further comprise a branch stable 315. The branch stable 315 provides stabling for the hyperloop vehicle 110 if a plurality of branch egress queues 323C is unavailable, not desired, inoperative, full, or a combination thereof.

The portal configuration parameters 302A comprises a branch egress queue 323A. The branch egress queue 323A is generally configured to queue the hyperloop vehicle 110 prior to exiting the hyperloop portal 115D.

The hyperloop portal 115D comprises a stabling egress queue 317. The stabling egress queue 317 provides a position for stabled hyperloop vehicles that are not destined for the plurality of branches 330Z at a given time.

The portal configuration parameters 302A comprise a portal egress 325A. The portal egress 325A provides a path for the hyperloop vehicle 110 to exit the portal 115B.

FIG. 3B is a block diagram illustrating a logical layout view represented as portal configuration parameters 302B. In the instant view, the portal configuration parameters 302B are associated with the portal 115G which is primarily used for commuting passengers. As shown, considerably more components are present within the logical layout. Further, the symbols on each of the portal configuration parameters 302B are dedicated to passenger use.

The portal configuration parameters 302B comprise the portal ingress 305A. The portal configuration parameters 302B comprise the arrival queue 307. The portal configuration parameters 302B comprise the branch ingress queue 319A.

The portal configuration parameters 302B comprise the plurality of branches 330Z. One of skill in the art will appreciate how the array of docking bays is represented as a logical array in the instant figure. Further, the number of branches in the plurality of branches 330Z may be varied as required by the stakeholders (and influenced by the alignment data).

The number of docking bays in the branches is different for each array. In the A array, the number of docking bays is four. However, in the B array, the number of docking bays is three. Thus, the designers may create varying layouts and configurations of hyperloop portal components in order to satisfy goals.

The portal configuration parameters 302B further comprise the arrival stable 311, the emergency path 309, the emergency stable 313, the branch stable 315, the branch egress queue 323A, and a stabling egress queue 317. The portal configuration parameters 302B further comprise a plurality of portal egresses 325Z—comprising the first portal egress 325A and a second portal egress 325B.

FIG. 3C is a block diagram illustrating a logical layout view represented as portal configuration parameters 302C. The hyperloop portal 115B is an example of a highly urbanized hyperloop portal that supports both cargo and passengers. When a designer is constructing a hyperloop portal, the capability to select the type of use for each component of the portal configuration parameters 302C is beneficial. By use the simulation module 211, the portal configuration parameters 302C may be tested by the selected use. For example, the simulation could show that mixed use is more efficient when measuring real estate costs but less beneficial for throughput of hyperloop vehicles. As such, complex and relatively simple designs of hyperloop portals is demonstrated by the portal configuration parameters 302C.

The portal configuration parameters 302C comprise a plurality of portal ingresses 305Z. The plurality of portal ingresses 305Z is comprised of the first portal ingress 305A, the second portal ingress 305B, and a third portal ingress 305C. The portal configuration parameters 302C further comprise the arrival queue 307, and a plurality of branch ingress queues 319Z. The plurality of branch ingress queues 319Z comprises the first branch ingress queue 319A, a second branch ingress queue 319B and a third branch ingress queue 319C.

The portal configuration parameters 302A further comprise the plurality of branches 330Z. The plurality of branches 330Z comprises an array from [A,E] for five branches with varying docking bays therein. The A array comprises eight docking bays; the B array comprises six docking bays; the C array comprises six docking bays; the D array comprises five docking bays; lastly, the E array comprises four docking bays.

The A array is dedicated to mixed use, thus allowing both cargo and/or passengers to dock at the docking bays (namely, 1-8). The B array is similarly configured. The C array is dedicated to cargo use. The D array is denoted as being dedicated to passenger usage. Finally, the E series is dedicated to mixed usage.

The portal configuration parameters 302A further comprise the arrival stable 311, the emergency path 309, the emergency stable 313, the branch stable 315, and the plurality of branch egress queues 323Z. The plurality of branch egress queues 323Z comprises the first branch egress queue 323A, the second branch egress queue 323B, and a third branch egress queue 323C.

The hyperloop portal 115B further comprises the stabling egress queue 317. The stabling egress queue 317 provides a position for stabled hyperloop vehicles that are not destined for the plurality of branches 330Z at a given time. The portal configuration parameters 302 further comprise the plurality of portal egresses 325Z. The plurality of portal egresses 325Z comprises the first portal egress 325A, the second portal egress 325B, and a third portal egress 325C.

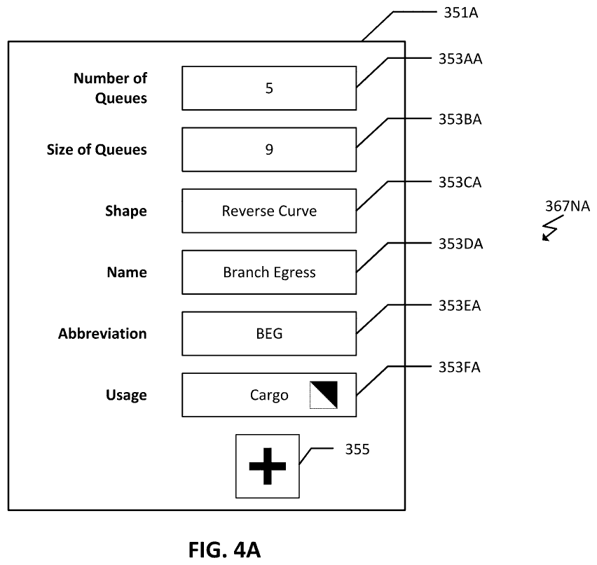

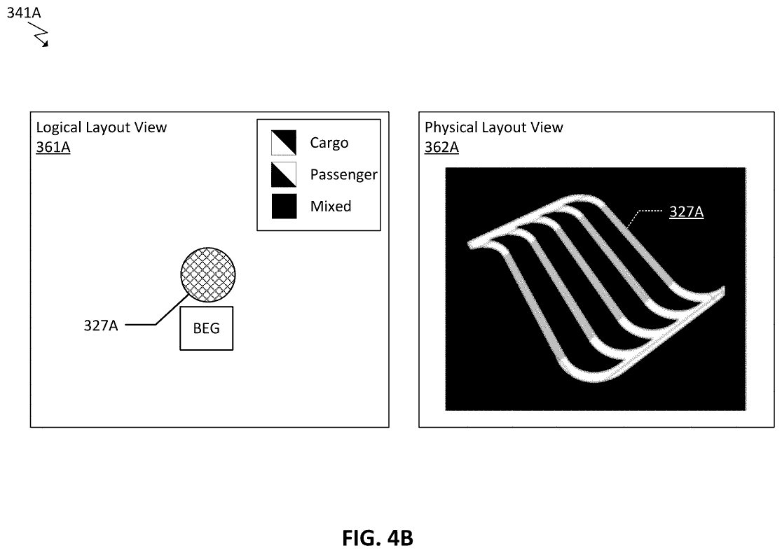

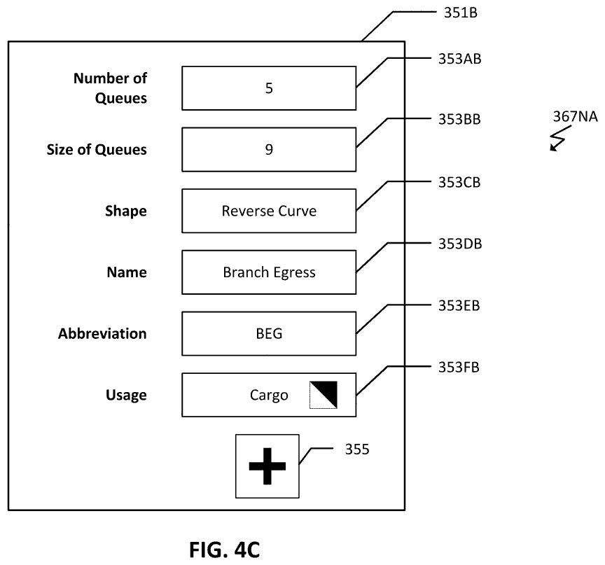

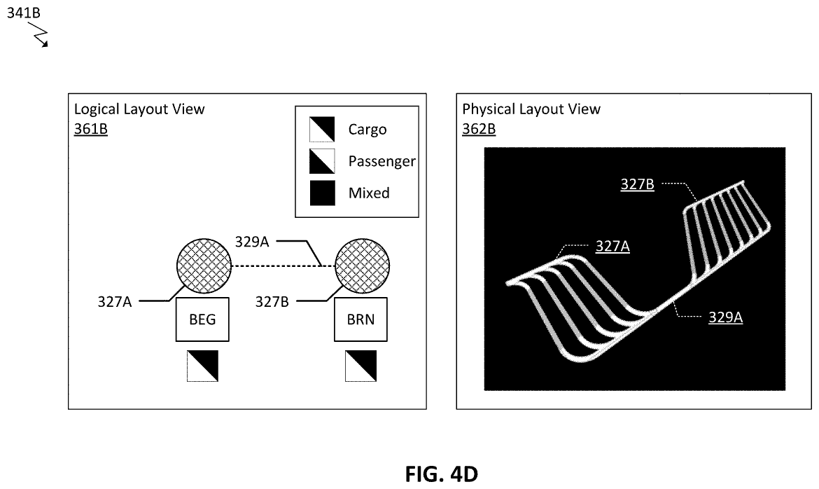

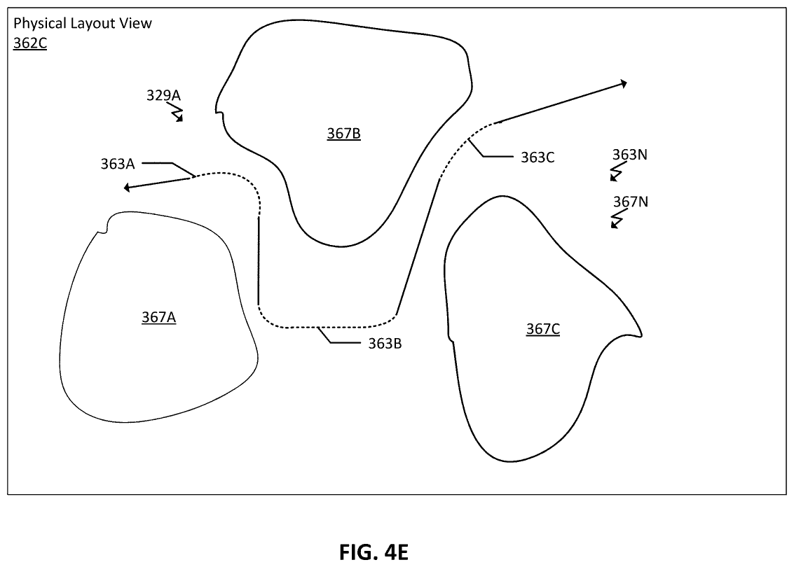

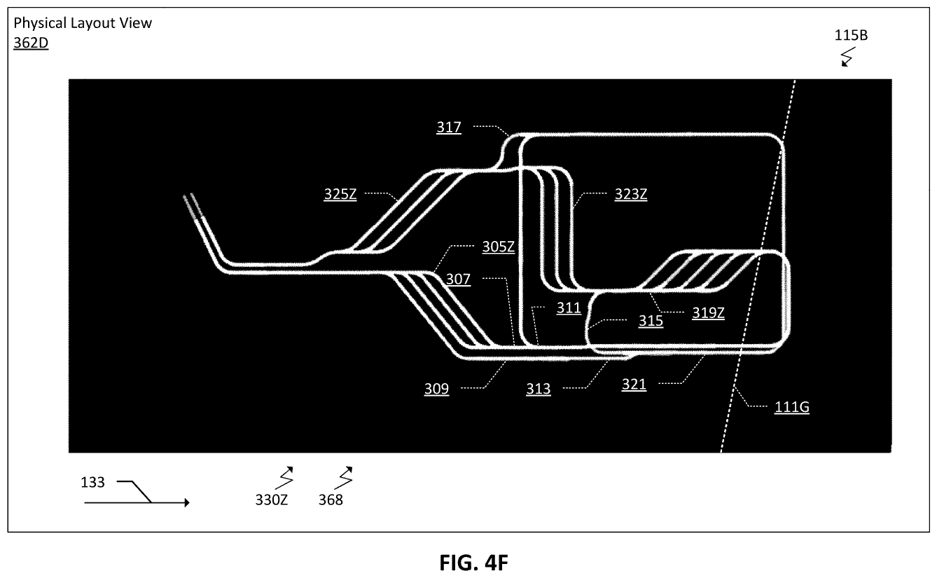

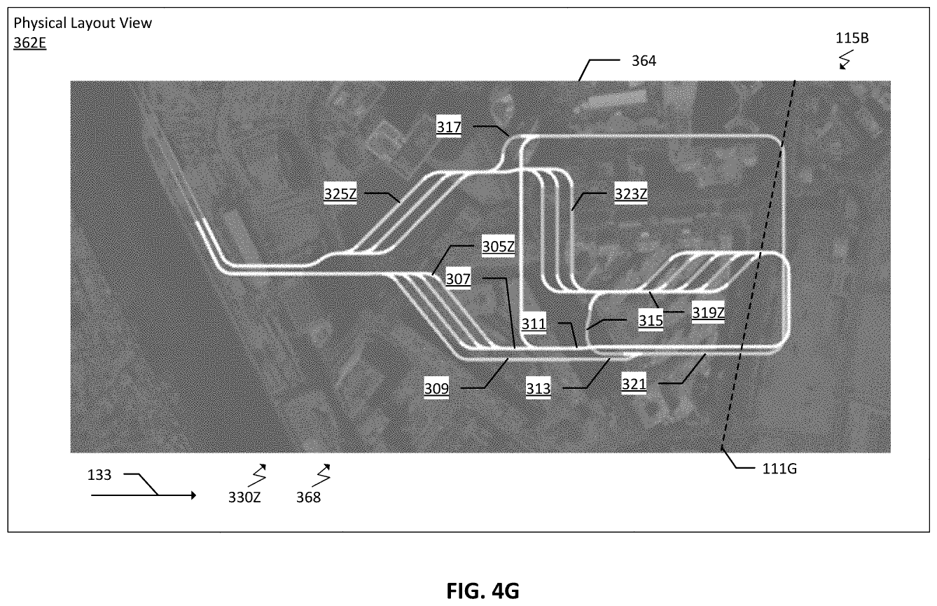

FIG. 4A is a block diagram illustrating a menu 351A. The menu 351A is a user interface (e.g., via the user interface 204) that enables a human user to enter parameters to configure a section of a hyperloop portal (e.g., the portal 115A). Thus, the instant view is one that a designer may interact with in order to use the design system 201.

In the instant figure, the reference shall end in A to indicate that this view is for a time at to. A subsequent view will show the changes to the fields shown in the menu 351A such that the changes may be demonstrated in various logical and physical views.

The menu 351 comprises a plurality of fields 367NA. The plurality of fields 367NA comprises a number of fields that enable portal configuration parameters 302A, 302B, 302C to be entered into the design system 201. For convenience, a plurality of portal configuration parameters 302N is defined as comprising the portal configuration parameters 302A, 302B, 302C. In particular, the plurality of fields 367NA comprises: a number-of-queues field 353AA, a size-of-queues field 353BA, a shape field 353CA, a name field 353DA, an abbreviation field 353EA, and a usage field 353FA.

The menu 351 is generally configured to enable a designer or engineer to select some of the plurality of portal configuration parameters 302N using a graphical interface (e.g., the user interface 204). The number-of-queues field 353AA is generally configured to enable selection of the number of queues. For example, the portal configuration parameters 302A comprise a branch with four queues (i.e., the branch [A,4]) and a branch with three queues (i.e., the branch [B,3]). The size-of-queues field 353BA is generally configured to enable selection of the queue size.

The shape field 353CA is generally configured to enable selection of the queue shape. Such shapes include: a reverse curve, a line, a curve, an arc, a vector, a spiral, a ray, etc. As shown in the instant figure, the shape field 353CA is set to a reverse curve.

The name field 353DA is generally configured to enable naming of a particular component, primarily for ease of use. However, the name field 353DA may be determined by other factors such as associated design plans or regulatory-imposed naming conventions. The abbreviation field 353EA is generally configured to enable naming of a particular component in a shortened form for similar purposes as the name field 353DA. The usage field 353FA is generally configured to enable selection between cargo, passenger, and/or mixed usage of the component. In the instant view, the usage field 353FA indicates cargo such that cargo payloads will utilize the component being designed viz. the branch egress shown in the menu 351A.

The menu 351A further comprises an add button 355 to add the section of the hyperloop portal according to the portal configuration parameters as entered in the associated parameter fields.

FIG. 4B is a block diagram illustrating a view 341A. The view 341A depicts a logical layout view 361A and a physical layout view 362A. The view 341A is generated based, in part, on the plurality of fields 367NA shown in FIG. 4A above. The logical layout view 361A is generated using the logical layout module 205. The physical layout view 362A is generated using the physical layout module 207.

The logical layout view 361A is generally configured to enable visual manipulation of portal components (as embodied in the plurality of portal configuration parameters 302N). The logical layout view 361A depicts the plurality of queues 327A generated using the menu 351A. The logical layout view 361A generally corresponds to the plurality of portal configuration parameters 302N. One of skill in the art will appreciate that the abbreviation set in the abbreviation field 353EA is reflected in the view 341A. The logical layout view 361A typically does not account for alignment data because the physical layout view 362A addresses alignment-data-based constraints.

The physical layout view 362A depicts the plurality of queues 327A in physical space. Having alignment data in the design system 201 enables the design system 201 (and associated processes) to generate a physical layout, such as the one shown for the plurality of queues 327A. Depending on the requirements, the alignment data may or may not be used to optimize the plurality of queues 329A for use in the physical layout view 362A. However, optimization is typically reserved for after the logical layout is completed such that the logical layout is substantially fixed in place.

FIG. 4C is a block diagram illustrating a menu 351B. The menu 351B is substantially similar to the menu 351A, shown in FIG. 4A above. The aim is to demonstrate the changes between the menus 351A, 351B, as shown in FIG. 4A and the instant view, respectively. A plurality of fields 367NB comprises: a number-of-queues field 353AB, a size-of-queues field 353BB, a shape field 353CB, a name field 353DB, an abbreviation field 353EB, and a usage field 353FB. The plurality of fields 367NB is substantially similar to the plurality of fields 367NA shown in FIG. 4A above.

The number-of-queues field 353AB is set to 5. The size-of-queues field 353BB is set to 9. The shape field 353CB is still set to an “Reverse Curve.” The name field 353DB is set to “Branch Egress.” The abbreviation field 353EB is set to “BEG.” The usage field 353FB is set to cargo.

FIG. 4D is a block diagram illustrating a view 341B. The view 341B is generated based, in part, on the plurality of fields 367NB shown in FIG. 4C above. The view 341B comprises a logical layout view 361B and a physical layout view 362B. The view 341B is generated, in part, based on the plurality of fields 367NB, shown in FIG. 4C. The logical layout view 361B is generated using the logical layout module 205. The physical layout view 362B is generated using the physical layout module 207.

The logical layout view 361B is substantially similar to the logical layout view 361A, shown in FIG. 4B above. However, the plurality of queues 327A is shown being connected to a plurality of queues 327B. A route 329A is shown to indicate that a physical connection between the pluralities of queues 327A, 327B.

The physical layout view 362B is substantially similar to the physical layout view 362A in FIG. 4B above. However, the pluralities of queues 327A, 327B are shown as being physically connected via the route 329A.

FIG. 4E is a block diagram illustrating a physical layout view 362C. The physical layout view 362C may be generated by the physical layout module 207, in either an unoptimized or optimized instance. The physical layout view 362C comprises a plurality of obstacles 367N and a plurality of curves 363N. The plurality of obstacles 367N comprises a first obstacle 367A, a second obstacle 367B, and a third obstacle 367C. An obstacle is generally a factor that affects the configuration of the hyperloop route 329A. For example, an obstacle may be a nature preserve wherein no construction may occur, thus prohibiting deployment of hyperstructure for hyperloop. Another obstacle may be expensive land that is cost-prohibitive. For example, deploying hyperloop may be difficult in dense urban areas and thus be more appropriate for suburb-to-suburb cargo shipments. One more example obstacle may be a geological obstruction such as a mountain, a lake, a river, a swamp, etc.

The plurality of obstacles 367N obstruct the straight path of the route 329A. As such, the plurality of curves 363N are introduced to the route 329A in order to avoid the plurality of obstacles 367N. The plurality of curves 363N comprises a first curve 363A, a second curve 363B, and a third curve 363C. The bin packing algorithm is configured to create an optimized path between the pluralities of queues 327A, 327B. The first curve 363A avoids the obstacles 367A, 367B. The curve 363B causes the route 329A to avoid the obstacles 367B, 367C. Lastly, the curve 363C causes the route 329A to return to a path that is substantially straight were the obstacle 367B not present.

Thus, the adjusted route 329A is optimized for the plurality of obstacles 367N. By use of the design system 201, a human designer can focus on the logical layout of the transportation network 101 without being overly concerned with alignment data. Further, the aspects optimized by the optimization module 209 is such that no human could possibly perform such optimizations by hand.

While the plurality of obstacles 367N is a specific example of alignment data that may be utilized for optimization, the alignment data is configured to represent a number of constraints affecting a logical layout and/or a physical layout. The plurality of obstacles 367N is an example of a geographic-based constraint.

FIG. 4F is a block diagram illustrating a physical layout view 362D. The physical layout view 362D comprises a portal physical layout 368 which is the physical representation of the portal configuration parameters 302B as shown in FIG. 3C above. The physical layout module 207 may be utilized to generate the physical layout view 362D. Alignment data has been considered by the optimization module 209 such that the physical layout view 362D represents a substantially optimized instance of the portal configuration parameters 302B as applied to a physical layout.

FIG. 4G is a block diagram illustrating a physical layout view 362E. The physical layout view 362E depicts a real-world map 364 upon which the portal physical layout 368 is overlaid. By associating the physical layout view 362E with the real-world map 364 during generation of the physical layout view 362E, the designer is able to see the designed component (e.g., the portal 115G) in a real-world context. Such real-world demonstration enables designers to communicate the final design to stakeholders such as operators, regulatory agencies, investors, etc. The real-world map 364 may be a satellite-based map, a terrain map, a street map, an infrastructure map, a demographic map, a real-estate-value map, or a combination thereof.

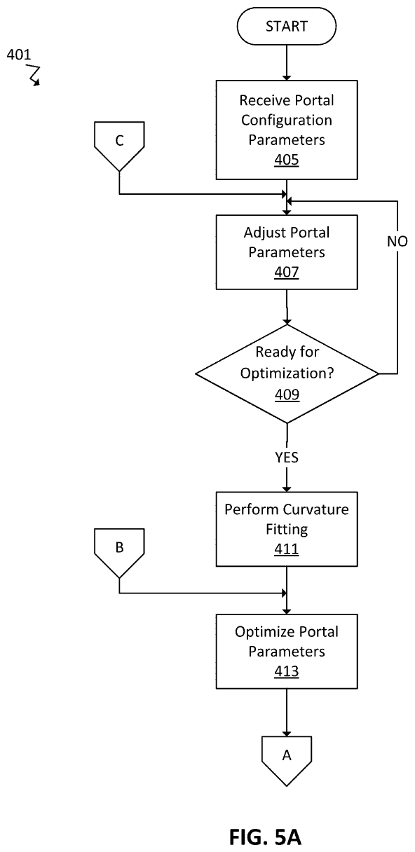

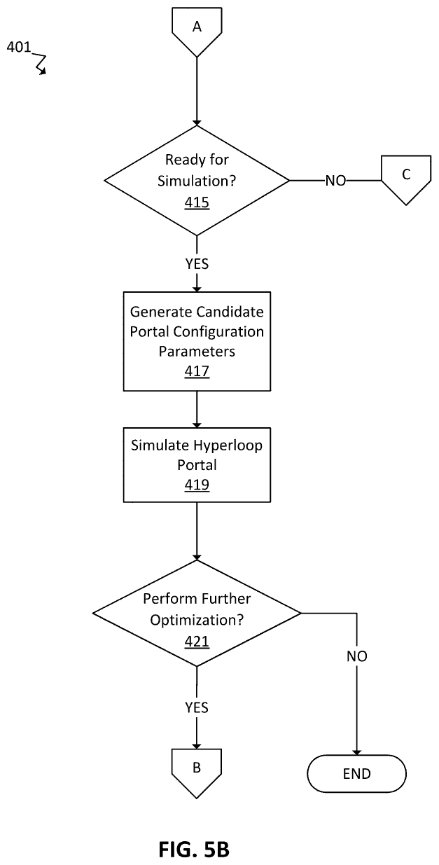

FIG. 5A is a flowchart illustrating a process 401. The process 401 begins at the start block 403 and proceeds to the block 405. At the block 405, the process 401 receives portal configuration input as portal configuration parameters 302A, 302B, 302C, either generated by a designer or generated by the process 401. The process 401 proceeds to the block 407.

At the block 407, the process 401 adjusts the portal configuration parameters 302A, 302B, 302C. For example, the designer may add a fourth branch ingress queue to the plurality of branch ingress queues 319Z as shown in FIG. 2A, above. The process 401 then proceeds to the decision block 409.

At the decision block 409, the process 401 determines whether the portal configuration parameters 302A, 302B, 302C are ready for curvature fitting and optimization. If the process 401 determines that the portal configuration parameters 302A, 302B, 302C are ready for curvature fitting and optimization, the process 401 then proceeds along the YES branch to the block 411. Returning to the decision block 409, if the process 401 determines that the portal configuration parameters 302A, 302B, 302C are not ready for curvature fitting and/or optimization, the process 401 proceeds along the NO branch to the block 407.

In one aspect, a bin packing algorithm may be utilized to perform the curvature fitting. As with cargo packing, the placement and fit of a hyperloop component (e.g., the portal 115B) is one in which resources are being placed, as optimally as possible, within a finite space.

At the block 411, the process 401 performs curvature fitting. The process 401 then proceeds to the block 413. The process 401 may fit a curve as shown in FIG. 4E with the plurality of curves 363N. For example, civil engineers may define an angle of minimum turning radius for a particular type of hyperloop tube. As such, the curvature fitting may conform the designed shape to the physical constraints.

At the block 413, the process 401 optimizes portal configuration parameters 302A, 302B, 302C. The optimization may relate to queue minimum turning radius, arc minimum turning radius, hyperloop vehicle velocity, hyperloop vehicle acceleration, technical floor/ceiling height, curve resolution, hyperloop vehicle dimensions, gap distance between adjacent tubes (or queues/stables), gap distance between adjacent hyperloop vehicles, the ramps in latitude, the ramps in longitude, the ramps in elevation, or a combination thereof.

The optimization may be performed based on alignment data that relates to the physical constraints of the portal configuration parameters 302A, 302B, 302C. As such, the portal configuration parameters 302A, 302B, 302C may be optimized by a geometric alignment algorithm, a genetic-algorithm-based alignment algorithm, or a combination thereof. Alignment data may relate to construction-based constraints (e.g., dimensions of hyperloop vehicle), operational-based constraints (e.g., maximum velocities), etc. The process 401 then proceeds to the off-page reference A.

FIG. 5B is a flowchart illustrating the process 401. The process 401 resumes at the off-page reference A. The process 401 proceeds to the decision block 415. At the decision block 415, the process 401 determines whether the portal configuration parameters 302A, 302B, 302C are ready for simulation. If the portal configuration parameters 302A, 302B, 302C are not ready for simulation, the process 401 proceeds along the NO branch to the off-page reference C—and then resumes at FIG. 3A above. Returning to the decision block 415, if the process 401 determines that the portal configuration parameters 302A, 302B, 302C are ready for simulation, the process 401 proceeds along the YES branch to the block 417.

At the block 417, the process 401 generates candidate portal configuration parameters. The candidate portal configuration parameters may be one instance of the portal configuration parameters 302A, 302B, 302C. For example, a given simulation may generate a number of candidate portal configuration parameters such that many evaluations may be performed for the portal configuration parameters 302A, 302B, 302C. Such multiplicity in candidates provides designers with the capability to understand how the various permutations of the portal configuration parameters 302A, 302B, 302C satisfy design goals, design constraints, operational constraints, geographic constraints, construction constraints, etc. One of skill in the art will appreciate that changes to the candidate portal configuration parameters affect an associated physical layout. Thus, a candidate physical layout may be similarly generated by the process 401. The process 401 then proceeds to the block 419.

At the block 419, the process 401 simulates the hyperloop portal 115B. The simulation provides designers with the information necessary to determine whether a given configuration of the portal configuration parameters 302A, 302B, 302C meets established design goals, construction-based constraints, geographic constraints, etc. However, the simulation may provide more information than simply whether the alignment data is satisfactory. For instance, several scenarios may be generated to evaluate a proposed design. The designer may create a rush-hour scenario as well as a midday scenario in order to see the effect of varying demands on the proposed design. One of skill in the art will appreciate how having multiple scenarios (in simulation) informs the designer whether the proposed design meets not only physical requirements but also dynamic requirements (e.g., rush-hour throughput of passengers). As stated, the portal configuration parameters, as candidates, may have an associated candidate physical layout that may be similarly simulated. The end aim is to generate a physical layout that meets expectations for operators, designers, and other stakeholders.

The process 401 sends the hyperloop vehicle 110 through various paths represented by the portal configuration parameters 302A, 302B, 302C. For example, the process 401 may send the hyperloop vehicle 110 along the emergency path 309 in order to simulate a distressed hyperloop vehicle and any interactions with hyperloop portal 115B that may need resolution, certification, testing, adjustment, etc.

Given that the portal configuration parameters 302A, 302B, 302C may have some aspects configurable and others not, the simulation may generate simulation data that may be associated with the portal configuration data 302A, 302B, 302C. For instance, the travel time of the hyperloop vehicle 110 may be determined and associated with the portal configuration parameters 302A, 302B, 302C. Such alignment-data-based results may be further simulated by the process 401. The process 401 then proceeds to the decision block 421.

At the decision block 421, the process 401 determines whether the process 401 may perform further optimization of the portal configuration parameters 302A, 302B, 302C. If the process 401 determines that the portal configuration parameters 302A, 302B, 302C may be further optimized, the process 401 proceeds along the YES branch to the off-page reference B—and then resumes at FIG. 3A above. If the process 401 determines that no further optimization is desired, the process 401 proceeds along the NO branch to the end block 423 and terminates.

Considerations for performing further evaluation may be performed by human interaction and/or the process 401 itself. In one aspect, the process 401 determines, based on a plurality of design goals, whether the candidate portal configuration parameters (and any associated physical layout) meet said design goals (e.g., reduced land footprint, increased efficiency of hyperloop vehicles, reduced carbon footprint, etc.). For instance, a plurality of analytics may be generated based on the candidate portal configuration parameters such that the process 401 may, in advance, determine the next plurality of candidate portal configuration parameters. On the other hand, a human designer may substantially manually select the better candidates from the candidate portal configuration parameters. In one aspect, the designer may be presented with the plurality of analytics such that any human-based decision is better informed.

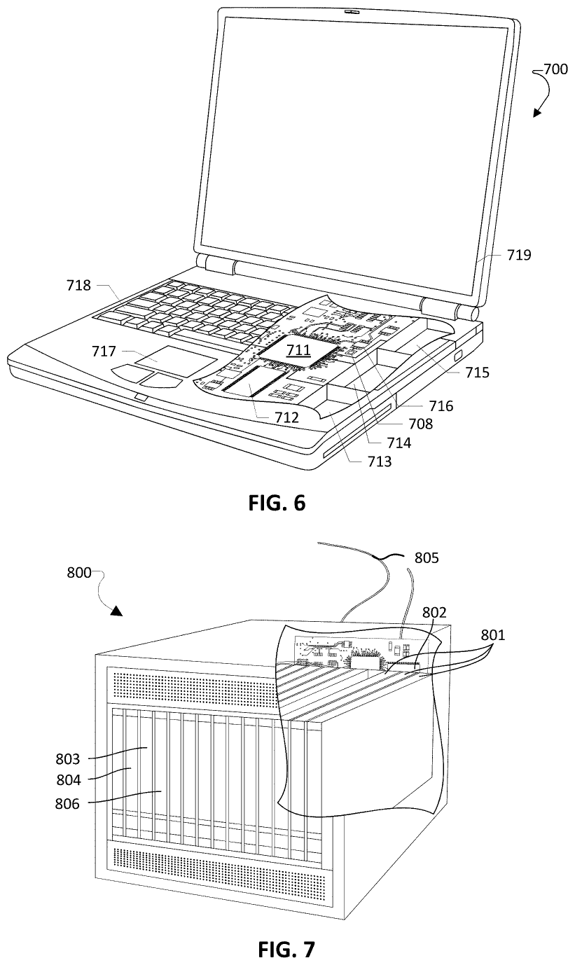

FIG. 6 is a block diagram illustrating a computing device 700 suitable for use with the various aspects described herein. The computing device 700 is configured to store and execute the design system 201, the portal configuration parameters 302A, 302B, 302C, the menus 351A, 351B, the logical layout views 361A, 361B, the physical layout views 362A, 362B, 362C, 362D, 362E, and the process 401.

The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711.

The computing device 700 may include a touchpad touch surface 717 that serves as the computing device's 700 pointing device, and thus may receive drag, scroll, flick etc. gestures similar to those implemented on computing devices equipped with a touch screen display as described above. In one aspect, the touch surface 717 may be integrated into one of the computing device's 700 components (e.g., the display). In one aspect, the computing device 700 may include a keyboard 718 which is operable to accept user input via one or more keys within the keyboard 718. In one configuration, the computing device's 700 housing includes the touchpad 717, the keyboard 718, and the display 719 all coupled to the processor 711. Other configurations of the computing device 700 may include a computer mouse coupled to the processor (e.g., via a USB input) as are well known, which may also be used in conjunction with the various aspects described herein.

FIG. 7 is a block diagram illustrating a server 800 suitable for use with the various aspects described herein. In one aspect, the server 800 is configured to store and execute the design system 201, the portal configuration parameters 302A, 302B, 302C, the menus 351A, 351B, the logical layout views 361A, 361B, the physical layout views 362A, 362B, 362C, 362D, 362E, and the process 401.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by insertion into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for designing a transportation network comprising a hyperloop portal, the method comprising:
receiving, at a processor, first portal configuration parameters, the first portal configuration parameters being associated with the hyperloop portal;
receiving, at the processor, first alignment data, the first alignment data being associated with the hyperloop portal;
generating, at the processor and based on the first portal configuration parameters, a first logical layout, the first logical layout representing the relationships between the first portal configuration parameters; and
generating, at the processor and based on the first logical layout and further based on the first alignment data, a first physical layout.

2. The method of claim 1, the method further comprising:
receiving, at the processor, a plurality of design goals, the plurality of design goals being configured to evaluate the first logical layout, the first physical layout, or a combination thereof.

3. The method of claim 2, the method further comprising:
optimizing, at the processor, the first logical layout, the first physical layout, or a combination thereof, the optimizing resulting in a second plurality of portal configuration parameters.

4. The method of claim 3, wherein the optimizing is performed using curvature fitting, geometric alignment, genetic-algorithm alignment, or a combination thereof.

5. The method of claim 4, wherein the curvature fitting generates a plurality of curves, the plurality of curves being based on the design goals and the first alignment data.

6. The method of claim 2, the method further comprising:
simulating, at the processor, the first physical layout;
evaluating, at the processor, the first physical layout, the evaluating being based on the plurality of design goals and the simulating; and
generating, at the processor, a third plurality of portal configuration parameters, the third plurality of portal configuration parameters being based on the evaluating of the first physical layout.

7. The method of claim 1, the method further comprising:
generating, at the processor, a real-world map; and
generating, at the processor and based on the first physical layout, a second physical layout, the second physical layout being associated with the real-world map.

8. The method of claim 1, wherein the first alignment data comprises construction-based constraints, operational-based constraints, geographic-based constraints, legal-based constraints, ingress geometry, egress geometry, ingress grade, egress grade, horizontal spacing, vertical spacing, geometric entity types, or a combination thereof.

9. The method of claim 1, wherein the first portal configuration parameters comprise portal ingress parameters, arrival queue parameters, emergency path parameters, branch ingress queue parameters, branch parameters, docking bay parameters, arrival stable parameters, emergency stable parameters, branch stable parameters, stabling egress queue parameters, branch egress queue parameters, portal egress parameters, tube parameters, or a combination thereof.

10. A design system configured to design a transportation network comprising a hyperloop portal, the design system comprising:
a memory;
a processor, the processor being configured to:
receive first portal configuration parameters, the first portal configuration parameters being associated with the hyperloop portal;
receive first alignment data, the first alignment data being associated with the hyperloop portal;
generate, based on the first portal configuration parameters, a first logical layout, the first logical layout representing the relationships between the first portal configuration parameters; and
generate, based on the first logical layout and further based on the first alignment data, a first physical layout.

11. The design system of claim 10, the processor being further configured to:
receive a plurality of design goals, the plurality of design goals being configured to evaluate the first logical layout, the first physical layout, or a combination thereof.

12. The design system of claim 11, the processor being further configured to:
optimize the first logical layout, the first physical layout, or a combination thereof, the optimizing resulting in a second plurality of portal configuration parameters.

13. The design system of claim 12, wherein the optimizing is performed using curvature fitting, geometric alignment, genetic-algorithm alignment, or a combination thereof.

14. The design system of claim 13, wherein the curvature fitting generates a plurality of curves, the plurality of curves being based on the design goals and the first alignment data.

15. The design system of claim 11, the processor being further configured to:
simulate the first physical layout;
evaluate the first physical layout, the evaluating being based on the plurality of design goals and the simulating; and
generate a second plurality of portal configuration parameters, the second plurality of portal configuration parameters being based on the evaluating of the second physical layout.

16. The design system of claim 10, the processor being further configured to:
generate a real-world map; and
generate, based on the first physical layout, a third physical layout, the third physical layout being associated with the real-world map.

17. The design system of claim 10, wherein the first alignment data comprises construction-based constraints, operational-based constraints, geographic-based constraints, legal-based constraints, ingress geometry, egress geometry, ingress grade, egress grade, horizontal spacing, vertical spacing, geometric entity types, or a combination thereof.

18. The design system of claim 10, wherein the first portal configuration parameters comprise portal ingress parameters, arrival queue parameters, emergency path parameters, branch ingress queue parameters, branch parameters, docking bay parameters, arrival stable parameters, emergency stable parameters, branch stable parameters, stabling egress queue parameters, branch egress queue parameters, portal egress parameters, tube parameters, or a combination thereof.

19. A computer-readable medium storing instructions that, when executed by a computer, cause the computer to:
receive, at a processor, first portal configuration parameters, the first portal configuration parameters being associated with the hyperloop portal;
receive, at the processor, first alignment data, the first alignment data being associated with the hyperloop portal;
generate, at the processor and based on the first portal configuration parameters, a first logical layout, the first logical layout representing the relationships between the first portal configuration parameters; and
generate, at the processor and based on the first logical layout and further based on the first alignment data, a first physical layout.

20. The computer-readable medium of claim 19, the instructions further causing the computer to:
receive, at the processor, a plurality of design goals, the plurality of design goals being configured to evaluate the first logical layout, the first physical layout, or a combination thereof; and
optimize, at the processor, the first logical layout, the first physical layout, or a combination thereof, the optimizing resulting in a second plurality of portal configuration parameters.
